(19) United States
(12) Patent Application Publication
(10) Pub. No.: US 2011/0173814 A1
(43) Pub. Date: Jul. 21, 2011

(54) Valve Seat Installation and Retrieval Tool

(75) Inventor: Pankaj H. Patel, Keller, TX (US)

(73) Assignee: Weir SPM, Inc., Fort Worth, TX (US)

(21) Appl. No.: 12/947,498

(22) Filed: Nov. 16, 2010

Related U.S. Application Data
(60) Provisional application No. 61/261,632, filed on Nov. 16, 2009.

(51) Int. Cl. B23P 6/00; B23P 19/04

(52) U.S. Cl. 29/890.121; 29/221.6

(57) ABSTRACT

A tool for replacing a valve seat of a reciprocating pump has a puller shaft connected to a puller head having at least two spring-biased dogs. An operator inserts the puller head into a valve bore and through a valve seat, the dogs retracting as the puller head moves through the valve seat, then snapping back outward. A hydraulic cylinder engages the puller shaft to exert a force on the puller shaft causing the dogs to dislodge the seat. The operator then places a replacement valve seat on a shoulder in the valve bore. The operator attaches an installing head to an installing shaft and inserts the installing head into the valve bore into contact with the replacement valve seat. The hydraulic cylinder applies a force in an opposite direction on the installing shaft to push the replacement valve seat into installed engagement.

### CROSS-REFERENCE TO RELATED APPLICATION

This application claims priority to provisional application 61/261,632, filed Nov. 16, 2009.

### FIELD OF THE INVENTION

This invention relates in general to tools for retrieving and installing valve seats in a fluid end of a reciprocating pump.

### BACKGROUND OF THE INVENTION

One type of well service pump is particularly used for hydraulic fracturing operations, also called “frac” operations. Fluid at high pressure is pumped down the well to cause the producing formation to fracture. Beads may be mixed into fluid being pumped to prop the cracks open. The pressures may exceed 10,000 psi, and the fluids are abrasive.

These pumps are commonly mounted to trucks that are dispensed almost daily for performing frac operations. Because of the severe operating conditions, the operators must change various components such as valves, valve seats and plunger seals frequently. It is important to be able to change out these components quickly.

A frac pump has a suction valve and a discharge valve for each plunger, and pumps have typically three or five plungers. The suction and discharge valves are located within valve bores that normally intersect the plunger bore at 90 degrees. Each suction valve bore is co-axial with the discharge valve bore and usually located below the plunger bore. Normally, the plunger bore extends past the valve and suction bores to an end wall of the pump. This extension portion comprises an access passage that allows the operator to reach into and remove the suction valve. The discharge valve is typically removed from above.

The valve seats are pressed into mating shoulders formed in the bore. If they are to be removed, the common practice is to employ bars and hammer to dislodge them. This can be difficult, particularly because it requires the operator to access the valve seats from below. Similarly, replacement valve seats are normally installed by a hammer and bar. Using a hammer and bar can lead to injury. Puller tools to remove valve seats have been built, but because of various problems, are not utilized extensively.

### SUMMARY

The method described herein includes providing a puller head having at least two dogs mounted thereto and securing the puller head to a puller shaft. The dogs are outwardly radially biased relative to an axis of the puller shaft. The operator inserts the puller head into a valve bore and through the valve seat in a first direction. The dogs retract as the puller head moves through the valve seat, then snap back outward. The operator then causes a force to be applied to the puller shaft in a second direction opposite to the first direction, which causes the dogs to dislodge the valve seat.

After retrieving the puller head and the puller shaft, the operator places a replacement valve seat on a shoulder in the valve bore. He attaches an installing head to an installing shaft and inserts the installing head into the valve bore and into contact with the replacement valve seat. He then causes a force to be applied to the installing shaft in the first direction to push the replacement valve seat into installed engagement with the shoulder.

Preferably the operator causes the forces to be applied to the shafts by extending the shaft through a hydraulic cylinder and actuating the hydraulic cylinder in either the second direction or first direction. The puller shaft and the installing shaft may be one and the same.

In a preferred embodiment, the coupling between the shaft and the hydraulic cylinder is via a piston nut and a shaft nut. The piston nut is secured within a piston passage extending through the piston. The piston nut has a hole through which the shaft extends. The shaft nut has a larger periphery or diameter than the piston nut hole. Movement of the piston causes the piston nut to apply a force to the shaft nut and the shaft.

Preferably, the shaft nut is secured to the shaft by a threaded engagement. This allows the operator to abut the shaft nut against the piston nut by rotating the shaft nut while the head is in contact with the valve seat.

Preferably the fluid end body of the pump and the hydraulic cylinder have mating threads. Securing the hydraulic cylinder to the fluid end body causes the installing force to be reacted through the cylinder into the fluid end body.

The fluid end body of the pump preferably has two valve seats, and an access passage intersects the valve bore between the two valve seats. After dislodging the lower valve seat with the puller tool, the operator can reach through the access passage and detaching the lower valve seat from the puller head. He then can lift the puller head up against the upper valve seat. Exerting an upward force on the puller shaft causing the dogs to dislodge the upper valve seat. The hydraulic cylinder can remain secured to the fluid end body for removing both of the valve seats by employing the access passage to retrieve the lower valve seat before retrieving the upper valve seat. The lower valve seat has too large of a diameter to allow it to be pulled upward through the upper valve seat.

### BRIEF DESCRIPTION OF DRAWINGS

FIG. 1 is a partially sectioned side view of a valve seat retrieval tool in accordance with this invention, shown being lowered into a valve passage of a pump fluid block.

FIG. 2 is an enlarged sectional view of a portion of the valve retrieval tool of FIG. 1, shown located below the valve seat in preparation to exerting a pulling force on the valve seat.

FIG. 3 is a sectional view illustrating a fluid cylinder installed on the pump fluid block and in engagement with the shaft of the retrieval tool for applying a pulling force on the shaft of the retrieval tool.

FIG. 4 is a partially sectioned view of the valve retrieval tool of FIG. 3, shown employed to retrieve a lower valve seat before retrieving the upper valve seat.

FIG. 5 is a side view of a valve installation tool that incorporates the shaft of the valve retrieval tool.

FIG. 6 is a sectional view of the valve installation tool of FIG. 5 and the fluid cylinder of FIG. 3 shown applying a pushing force on a lower valve seat.

### DETAILED DESCRIPTION OF THE INVENTION

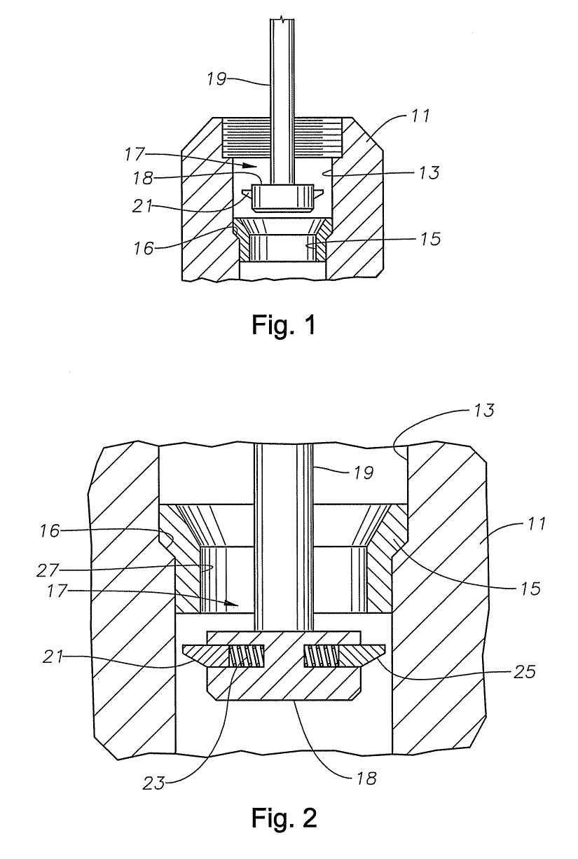

Referring to FIG. 1, a pump fluid block 11 is shown partially in section. Pump fluid block 11 is a fluid portion of a large reciprocating pump such as used for high pressure fluid injection into oil and gas wells during hydraulic fracturing operations. Pump fluid block 11 has a number of valve passages 13 (only one shown), each containing a valve seat 15. Valve passage 13 is shown extending vertically, but it could be oriented horizontally or in other directions. The terms such as “upper” or “upward” and “lower” or “downward” are used only for convenience. Valve seat 15 is pressed with an interference fit onto an upward facing conical shoulder 16 in valve passage 13. A valve member (not shown) would normally be mounted above valve seat 15, the valve member having a mating surface for engaging valve seat 15 and a spring that urges the valve member against the seat. The valve member will be removed prior to removing valve seat 15.

FIG. 1 shows a retrieval or removal tool 17 for valve seat 15 in the process of being inserted into valve passage 13. Removal tool 17 includes an enlarged head 18 secured to a shaft 19, such as by threads. Head 18 has and two or more dogs 21 mounted thereto that are urged radially outward relative to an axis of shaft 19. Referring to FIG. 2, dogs 21 slide between contracted and radially expanded positions relative to the axis of shaft 19. Springs 23 in head 18 engage the inner ends of dogs 21 for urging dogs 21 outward. Dogs 21 may have chamfers 25 on the lower outer ends for facilitating sliding past valve seat bore 27. Head 18 of retrieval tool 17 is generally cylindrical and has a smaller outer diameter than the inner diameter of valve seat bore 27. The operator can manually push on shaft 19 to force head 18 downward through bore 27 of valve seat 15, which causes dogs 25 to retract, and then expand outward again to an outer diameter that is greater than the inner diameter of seat bore 27.

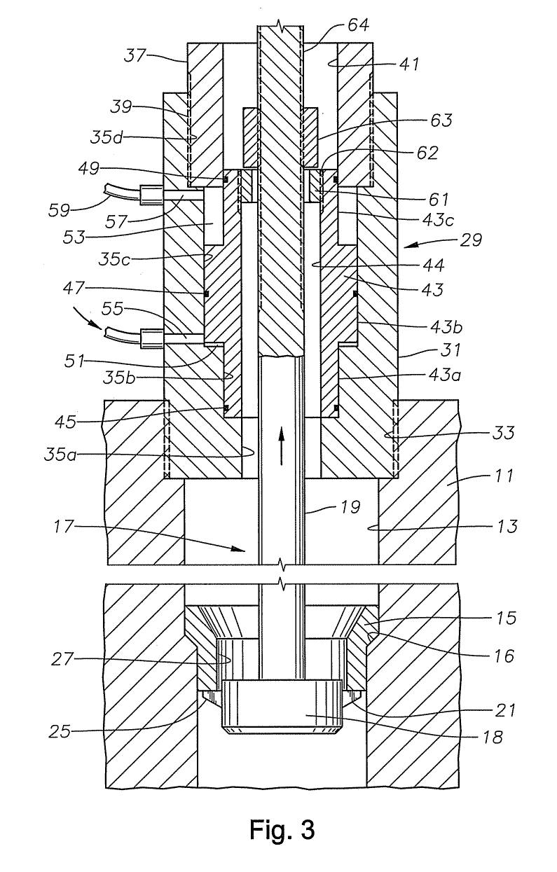

Referring to FIG. 3, the operator may use a fluid cylinder 29 to exert an upward force on shaft 19 to dislodge valve seat 15 from valve passage 13. Fluid cylinder 29 may be a variety of types and may be either hydraulically or pneumatically driven. In this embodiment, fluid cylinder 29 has a housing 31 that has a generally cylindrical exterior. Housing 31 may have an external set of threads formed on its lower end for engaging a threaded counterbore 33 located at the upper end of valve passage 13. The external threads could alternately be located on a sleeve attached to housing 31. Threaded counterbore 33 normally receives a threaded cap (not shown) to close valve passage 13 while fluid block 11 is in operation. Threaded counterbore 33 has a larger diameter than the diameter of valve passage 13 immediately below counterbore 33. Other arrangements to quickly secure fluid cylinder 29 to fluid block 11 and release it from fluid block 11 may alternately be employed.

Housing 31 has a bore extending completely through it for the insertion of shaft 19. The passage includes a first or lowermost bore section 35a; a second bore section 35b joining first bore section 35a; a third bore section 35c joining second bore section 35b; and a fourth bore section 35d joining third bore section 35c. In this embodiment, bore sections 35a, 35b, 35c, and 35d have different diameters, with the smallest being first bore section 35a and the largest being fourth bore section 35d. Third bore section 35c is greater in diameter than second bore section 35b. A retainer sleeve 37 with external threads 39 may be secured into fourth bore section 35d. Retainer sleeve 37 has a bore 41 that may be the same diameter as second bore section 35b.

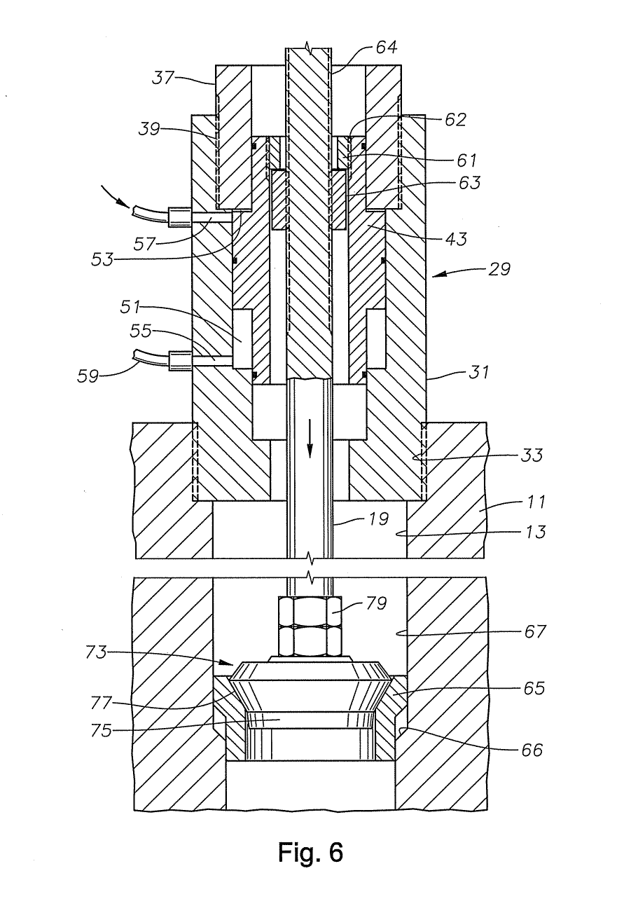

Prior to securing retainer sleeve 37, a piston 43 is installed within second and third bore sections 35b and 35c. Piston 43 strokes between the lower position shown in FIG. 3 and the upper position shown in FIG. 6. Piston 43 has a lower outer diameter portion 43a that fits closely and reciprocates within second bore section 35b. Piston 43 has a central outer diameter portion 43b that fits closely and reciprocates within third bore section 35c. Piston 43 has an upper outer diameter portion 43c that fits closely and reciprocates within retainer sleeve bore 41. Piston 43 has an axial passage 44 extending from its upper end through its lower end. Piston passage 44 may have a uniform inner diameter that is greater than the outer diameter of shaft 19. A lower seal 45 seals between piston lower outer diameter portion 43a and second bore section 35b. A central seal 47 seals between piston central outer diameter portion 43b and third bore section 35c. An upper seal 49 seals between piston upper outer diameter portion 43c and inner sleeve bore 41.

A lower chamber 51 is defined between lower seal 45 and central seal 47. Lower chamber 51 changes in volume depending on the position of piston 43. In the position shown in FIG. 3, lower chamber 51 has a minimum volume and in FIG. 6, it has a maximum volume. Similarly, an upper chamber 53 is defined by central seal 47 and upper seal 49. In FIG. 3, upper chamber 53 is at its maximum volume and in FIG. 6, it is at its minimum volume. A lower port 55 extends through housing 31 laterally outward from lower chamber 51. An upper port 57 extends laterally through housing 31 from upper chamber 53 to the exterior. Lower port 55 and upper port 57 are each connected to a separate line or tube 59 for supplying fluid under pressure to lower chamber 51 or upper chamber 53. Supplying fluid pressure to lower port 55 will cause piston 43 to move upward. Supplying fluid pressure to upper port 57 will cause piston 43 to move downward.

A variety of engaging devices may be employed to interconnect piston 43 with shaft 19 to cause it to move upward when piston 43 moves upward and downward when piston 43 moves downward. The engaging device in this example includes a piston nut 61 secured to piston 43 by threads 62 within piston passage 44 at its upper end. Piston nut 61 comprises a cylindrical sleeve with an inner diameter greater than the outer diameter of shaft 19. The engaging device also includes a shaft nut 63 secured to a shaft thread 64 located on and extending along the exterior of shaft 19. Shaft nut 63 is positioned above piston nut 61 when using to retrieve valve seat 15 and my also be a cylindrical sleeve. The outer diameter of shaft nut 63 is greater than the inner diameter of piston nut 61 so as to transfer an upward force being exerted by piston 43 to shaft nut 63, which in turn causes shaft 19 to move upward. Preferably, the outer diameter of shaft nut 63 is smaller than the inner diameter of retainer sleeve bore 41 so as to allow one to manually grip and rotate shaft nut 63 while it is inside retainer sleeve 37.

In one mode of operation of the embodiment of FIGS. 1-3, the operator will remove the access cap (not shown) and valve element (not shown) from valve passage 13. The operator inserts shaft 19 through fluid cylinder 29 and places fluid cylinder piston 43 in the lower position. The operator secures retrieval head 18 to the lower end of shaft 19 and shaft nut 63 to shaft threads 64 above piston nut 61. The operator manually pushes retrieval tool 17 downward through valve seat 15 to the position in FIG. 2. The operator will manually rotate shaft nut 63 downward on shaft 19 until it rests on piston nut 61. Dogs 21 should be located slightly below or touching the lower end of valve seat 15. Shaft 19 will be constrained against axial movement by the engagement of dogs 21 with valve seat 15 at the lower end and with shaft nut 63 resting on piston nut 61 at an upper end of the assembly.

The operator then applies fluid pressure, either pneumatic or hydraulic, to lower port 55. This fluid pressure pressurizes lower chamber 51, pushing piston 43 upward. Piston nut 61 will push upward on the lower end of shaft nut 63, transferring an upward force to shaft 19. Shaft 19 moves upward, transferring the upward force into retrieval head 18 and dogs 21. The upward force passes from dogs 21 to valve seat 15, causing it to dislodge from its position within valve passage 13 and move upward. Once dislodged, the operator can unscrew fluid cylinder 29 from threaded counterbore 33, then lift the entire assembly to pull retrieval tool 17 and valve seat 15 upward and out of valve passage 13.

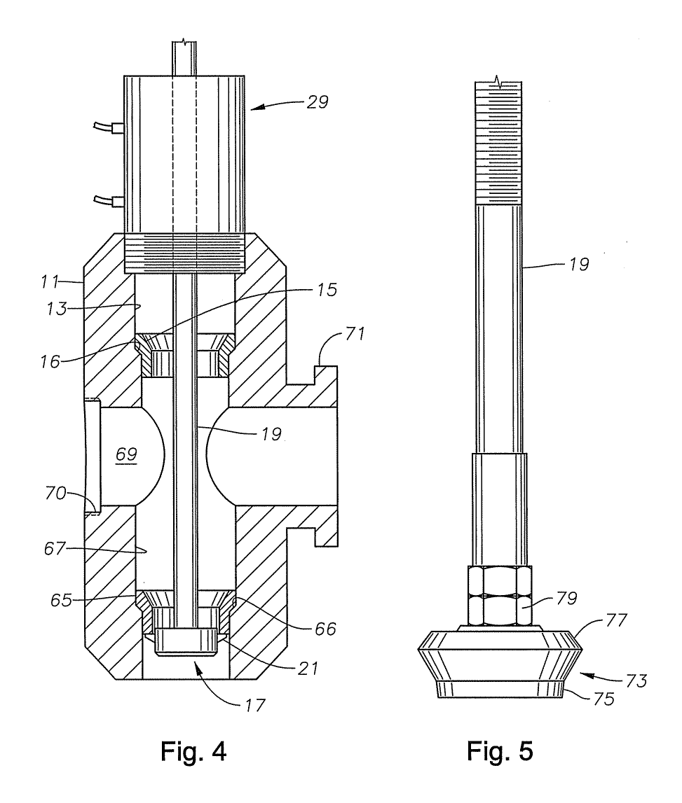

FIG. 4 illustrates more features of pump fluid block 11. Normally, a lower valve seat 65 will be mounted within a lower valve passage 67 that is co-axial with the first mentioned valve passage 13, which may be referred to as upper valve passage 13. Lower valve passage 67 and upper valve passage 13 are intersected by a plunger bore 69 that has an axis perpendicular to the common axis of passages 13 and 67. Normally, a piston type plunger (not shown) will stroke along plunger bore 69, causing the valves (not shown) located within passages 13 and 67 to open and close with each plunger stroke. Normally the upper valve will open on the discharge stroke and the lower valve will open on the suction stroke.

FIG. 4 also shows that typically pump fluid block 11 will have a flange 71 for bolting to a power section of the pump, which includes a crankshaft and gear mechanism. Pumps of this nature typically have three or more plungers and sets of suction and discharge valves located side-by-side. Fluid is normally drawn in through the lower valve passages 67 and discharged out the upper valve passages 13. An intake manifold (not shown) may be attached to the lower ends of lower valve passages 67.

Lower valve seat 65 is press-fitted onto an upward-facing conical shoulder 66, resulting in a larger diameter in lower valve passage 67 above shoulder 66 than below. Lower valve seat 65 thus cannot be removed by moving it downward in lower valve passage 67. Also, lower valve seat 65 may have the same dimensions as upper valve seat 15 or otherwise not be small enough to be pulled upward through upper valve passage 13 even if upper valve seat 15 were retrieved first. However, plunger bore 69 has an access opening 70 that is closed during pump operation by a threaded access cap (not shown). The operator wishing to pull lower valve seat 65 may utilize opening 70 in plunger bore 69 to retrieve and install lower valve seat 65.

In one method, lower valve seat 65 is retrieved before upper valve seat 15, although this could be reversed. FIG. 4 illustrates that shaft 19 is long enough for the operator to insert retrieval tool 17 through upper valve passage 13, upper valve seat 15 and into lower valve passage 67 to a position where dogs 21 are below lower valve seat 65. The operator will adjust shaft nut 63 (FIG. 3) downward to contact the upper end of piston nut 61 (FIG. 3) while dogs 21 are just below lower valve seat 65. The operator supplies fluid to lower port 55 of fluid cylinder 29 to exert an upward force on shaft 19, causing lower seat 65 to dislodge. The operator may then grip shaft 19 and manually lift retrieval tool 17 until retrieval head 18 is located within plunger bore 69. The operator may then reach through opening 70 and manually depress dogs 21 inward to allow lower seat ring 65 to drop downward over retrieval head 18. The operator withdraws lower valve seat 65 through opening 70 and pulls shaft 19 upward until retrieval head dogs 21 abut upper valve seat 15. The operator then repeats the process described above.

After both valve seats 15 and 65 are retrieved, the operator may then install new valve seats 15 and 65. An installing head 73, illustrated in FIG. 5, may be employed to force lower seat 65 (FIG. 4) and upper seat 15 (FIG. 3) into their installed positions. Installing head 73 may have its own shaft 19 or it may be secured to the same shaft 19 that previously supported retrieving head 18. Installing head 73 has a circular, slightly conical lip 75 on its lower end that is adapted to fit within the interior of valve seat 15 or valve seat 65, as shown in FIG. 6. Referring still to FIG. 5, lip 75 depends from a conical flange 77 that will contact and bear against the conical upper surfaces of valve seats 15 and 65. Preferably, hexagonal flats or drive surfaces 79 are formed on the upper end of installing head 73. Similar drive surfaces are located on the lower end of shaft 19 for receiving wrenches to secure the mating threads of installing head 73 on shaft 19 after removing retrieving head 18 from shaft 19. In the preferred embodiment, the maximum outer diameter of installing head 73 is less than the diameter of upper valve passage 13 below shoulder 16.

The same fluid cylinder 29 may be employed for press-fitting valve seats 15 and 65 that is used to retrieve the valve seats. However, in this example, fluid cylinder 29 is altered slightly when changing it from retrieving to installing and vice-versa. The operator adjusts shaft nut 63 on threads 64 so that it is below piston nut 61, rather than above. This may be performed by removing piston nut 61, inserting shaft 19 and shaft nut 63 into fluid cylinder 29, then re-installing piston nut 61 above shaft nut 63. It could also be done by inserting shaft 19 and shaft nut 63 into fluid cylinder 29 from the lower end.

In this example, lower valve seat 65 is installed first, then upper seat 15, but this process could be reversed. FIG. 6 illustrates installing head 73 in the process of installing lower valve seat 15. Using access port 70 and plunger bore 69 (FIG. 4), the operator manually places lower valve seat 65 on shoulder 66. Lower valve seat 65 will not yet be fully installed in shoulder 66 as this requires a substantial force. The operator attaches installing head 73 to shaft 19 and inserts shaft 19 and head 73 through upper valve passage 13 until its lower end is in plunger passage 69. Installing head 73 passes below shoulder 16 (FIG. 4) because of its smaller outer diameter and lands on the upper end of lower valve seat 65. The operator adjust shaft nut 63 to the desired approximate distance from installing head 73. The operator places piston 43 in the upper position shown in FIG. 6. The operator lowers fluid cylinder 29 over shaft 19 and secures its threads to threaded bore 33. The operator then inserts piston nut 61 over shaft 19 and secures it to threads 62 with the lower end of piston nut 61 abutting the upper end of shaft nut 63.

The operator applies fluid pressure into upper port 57, which pressurizes upper chamber 53, forcing piston 43 downward. Piston nut 61 transfers the force to shaft nut 63, which in turn transfers the force to shaft 19. Shaft 19 moves downward and transfers the downward force through installing head 73 against valve sleeve 65, forcing it downward into its proper position on shoulder 66.

The operator may then release the fluid pressure and remove fluid cylinder 29 from fluid block 11, bringing along with it shaft 19 and installing head 73. The operator inserts the upper valve seat 15 (FIG. 4) through the open upper end of upper valve passage 13 and places it on shoulder 16. The operator inserts installing head 73 onto upper valve seat 15 while attached to shaft 19. The operator secures fluid cylinder 29 to counterbore threads 33 and repeats the process described above to push upper valve seat 15 into shoulder 16.

The tool described is used both to remove and install valve seats. The tool eliminates having to deliver blows to bars to release and install valve seats.

While shown in only one of its fauns, it should be apparent to those skilled in the art that the method and apparatus described are susceptible to various changes and improvements.

1. A method of replacing a valve seat of a reciprocating pump, comprising:
(a) providing a puller head having at least two dogs mounted thereto and securing the puller head to a puller shaft, the dogs being outwardly radially biased relative to an axis of the puller shaft;
(b) inserting the puller head into a valve bore and through the valve seat in a first direction, the dogs retracting as the puller head moves through the valve seat, then snapping back outward;
(c) exerting a force on the puller shaft in a second direction opposite to the first direction, causing the dogs to dislodge the seat, and retrieving the puller head and the puller shaft;
(d) placing a replacement valve seat on a shoulder in the valve bore;
(e) attaching an installing head to an installing shaft and inserting the installing head in a first direction into the valve bore and into contact with the replacement valve seat; then
(f) applying a force in the first direction on the installing shaft to push the replacement valve seat into installed engagement with the shoulder.

2. The method according to claim 1, wherein securing the puller head to the puller shaft in step (a) comprises causing relative rotation between the puller head and the puller shaft to secure a threaded engagement between the puller head and the puller shaft.

3. The method according to claim 1, wherein:
step (c) comprises extending the puller shaft through a hydraulic cylinder and actuating the hydraulic cylinder in the second direction to exert the force in the second direction; and
step (f) comprising extending the installing shaft through the hydraulic cylinder and actuating the hydraulic cylinder in the first direction to exert a force in the first direction.

4. The method according to claim 1, wherein the puller shaft and the installing shaft are one and the same.

5. The method according to claim 1, further comprising:
providing a hydraulic cylinder having a piston with a central passage and a piston nut secured therein having a piston nut hole therethrough;
step (c) comprises extending a second end of the puller shaft through the passage and the piston nut hole, and securing a shaft nut to the puller shaft on a side of the piston nut opposite the puller head, the shaft nut having a larger outer periphery than an inner diameter of the piston nut hole; then
actuating the hydraulic cylinder in the second direction to cause the piston nut to exert a force in the second direction on the shaft nut.

6. The method according to claim 5, wherein:
step (f) comprises securing the shaft nut to the installing shaft and extending the installing shaft through the piston nut hole with the shaft nut on the first side of the piston nut; and
actuating the hydraulic cylinder in the first direction to cause the piston nut to exert a force in the first direction on the shaft nut.

7. The method according to claim 6, wherein:
the shaft nut is secured to the installing shaft by a threaded engagement; and
step (f) comprises adjusting the shaft nut into contact with the piston nut and the installing head into contact with the replacement valve seat before actuating the hydraulic cylinder.

8. The method according to claim 5, wherein the valve bore is located within a fluid end body of the reciprocating pump, and the method further comprises:
providing the fluid end body with threads and the hydraulic cylinder with mating threads, and securing the hydraulic cylinder to the fluid end body with the threads to react the force applied in the first direction from the hydraulic cylinder to the fluid end body.

9. A method of removing upper and lower valve seats of a reciprocating pump, the valve seats being located within a valve bore intersected by an access passage, the method comprising:
(a) providing a puller head having at least two dogs mounted thereto and securing the puller head to a puller shaft, the dogs being radially outward biased relative to an axis of the puller shaft;
(b) inserting the puller head downward into the valve bore and through both of the valve seats, the dogs retracting as the puller head moves through the valve seats, then snapping back outward;
(c) exerting an upward force on the puller shaft, causing the dogs to dislodge the lower valve seat, and moving the puller head and the lower valve seat up into alignment with the access passage;
(d) reaching into the access passage, detaching the lower valve seat from the puller head, and retrieving the lower valve seat through the access passage;
(e) lifting the puller head and the puller shaft upward from alignment with the access port into engagement with the upper valve seat; then
(f) exerting an upward force on the puller shaft, causing the dogs to dislodge the upper valve seat

10. The method according to claim 9, after step (f) further comprising:
reaching into the access passage and placing a replacement lower valve seat on a lower shoulder within the valve bore;
attaching an installing head to an installing shaft and inserting the installing head downward into the valve bore into engagement with the replacement lower valve seat; and
applying a downward force on the installing shaft to press the replacement lower valve seat into the lower shoulder.

11. The method according to claim 9, wherein securing the puller head to the puller shaft in step (a) comprises causing relative rotation between the puller head and the puller shaft to secure mating threads of the puller head and the puller shaft to each other.

12. The method according to claim 9, further comprising:
providing a hydraulic cylinder having a piston with a central passage and a piston nut secured therein having a piston nut hole therethrough;
step (c) comprises extending an upper end of the puller shaft through the piston nut hole, and securing a shaft nut to the puller shaft on lower side of the piston nut, the shaft nut having a larger outer periphery than an inner diameter of the piston nut hole; then
actuating the hydraulic cylinder in an upward direction to cause the shaft nut to engage the piston nut and exert an upward force on the shaft nut.

13. The method according to claim 12, wherein step (c) further comprises:
securing the shaft nut to the puller shaft by a threaded engagement;
after the dogs are located below the valve seat, rotting the shaft nut, so as to move the puller shaft upward until the dogs abut a lower side of the valve seat; then
actuating the hydraulic cylinder.

14. The method according to claim 12, further comprising:
after step (f), reaching into the access passage and placing a replacement lower valve seat on a lower shoulder within the valve bore;
attaching an installing head to an installing shaft, inserting the installing head downward into the valve bore into engagement with the replacement lower valve seat; and
attaching the shaft nut to the shaft below the piston nut; and
actuating the hydraulic cylinder in the downward direction to cause the piston nut to exert a downward force on the shaft nut.

15. A valve seat tool, comprising:
a hydraulic cylinder having a piston with a piston passage therethrough;
a piston nut that releasably secures within the piston passage, the piston nut having a hole therethrough;
a puller shaft;
a puller head secured to one end of the puller shaft, the puller head having at least two dogs that are spring-biased in a radial outward direction relative to an axis of the puller shaft to snap under a valve seat;
a shaft nut releasably secured by threads to the puller shaft, the shaft nut having an outer periphery larger than a diameter of the hole in the nut; and
the shaft nut being located above the piston nut while in a removal mode, which causes upward movement of the piston and the piston nut to apply an upward force to the shaft nut to move the puller head and the valve seat upward.

16. The tool according to claim 15, wherein the piston nut is secured to the piston by a set of internal threads in the piston passage.

17. The tool according to claim 15, wherein the puller shaft is secured to the puller shaft by threads.

18. The tool according to claim 15, further comprising:
an installing shaft;
an installing head having an annular conical bevel on a lower end configured to engage an upper end of a replacement valve seat;
the shaft nut being releasably secured by threads to the installing shaft; and
the shaft nut being located below the piston nut while in an installing mode, which causes downward movement of the piston and the piston nut to apply a downward force to the shaft nut to move the installing head and the valve seat downward.

19. The tool according to claim 15, wherein the puller shaft and the installing shaft are one and the same.

20. The tool according to claim 15, further comprising:
a set of external threads on the hydraulic cylinder, the threads being sized to engage a set of internal threads provided on a body containing the valve seat.
